(19) United States
(12) Patent Application Publication
(10) Pub. No.: US 2019/0101994 A1
(43) Pub. Date: Apr. 4, 2019

(54) INPUT PEN

(71) Applicant: Sharp Kabushiki Kaisha, Osaka (JP)

(72) Inventor: Takatoshi KIRA, Sakai City (JP)

(21) Appl. No.: 16/127,277

(22) Filed: Sep. 11, 2018

(30) Foreign Application Priority Data
Oct. 4, 2017 (JP) 2017-194020

(51) Int. Cl. G06F 3/0354; G06F 3/038; G06F 3/01

(52) U.S. Cl. CPC G06F 3/03545; G06F 3/016; G06F 3/0383

(57) ABSTRACT

An input pen includes: a casing; a pen tip disposed at a first end of the casing; a vibrating unit housed in the casing; and a vibration transmission unit disposed between the vibrating unit and the pen tip. The vibrating unit is configured to vibrate in the vertical direction. The vibration transmission unit is configured to convert the vibration of the vibrating unit into a vibration in the horizontal direction.

### CROSS-REFERENCE TO THE RELATED APPLICATIONS

This application claims priority under 35 U.S.C. § 119 (a) on Patent Application No. 2017-194020 filed in Japan on Oct. 4, 2017, the entire contents of which are herein incorporated by reference.

### TECHNICAL FIELD

The present invention relates to an input pen for an input device.

### BACKGROUND OF THE INVENTION

Nowadays, mobile phone terminals and tablets are widely spread, and as a result, devices to which information is input by direct contact with the display are increased. For such devices, an input pen (stylus pen) is used in order to achieve accurate input. However, such an input pen generates very low friction between the display and slides too much on the display, which hardly gives a user a sense of touch. Thus, it is difficult to give a user a good writing feeling. In order to address this problem, an input pen is proposed, which gives a user something like uneven texture by vibration of the input pen itself.

In a drawing device disclosed in JP 2014-222492 A, a drive unit that vibrates the drawing device is disposed in the casing at a position in a range of 10 to 80 mm from the tip of a casing. However, in the above drawing device, although the position of the drive unit is defined, the vibration is transmitted to the entire casing. Thus, when the drawing device makes contact with a drawing subject, the drawing device itself vibrates, and such a vibration is also transmitted to the pen tip to cause a jaggy line.

The present invention was made in consideration of the above problem, an object of which is to provide an input pen in which vibration is reduced at a pen tip while it is transmitted to the fingers of a user so as to give the user a good writing feeling.

### SUMMARY OF THE INVENTION

The input pen of the present invention is an input pen for an input device, and includes: a casing; a pen tip disposed at a first end of the casing; a vibrating unit housed in the casing; and a vibration transmission unit disposed between the vibrating unit and the pen tip. When a longitudinal direction of the input pen is set to a vertical direction and a direction that is orthogonal to the vertical direction is set to a horizontal direction, the vibrating unit is configured to vibrate in the vertical direction, and the vibration transmission unit is configured to convert the vibration of the vibrating unit into a vibration in the horizontal direction.

In the input pen of the present invention, a linear actuator may be used as the vibrating unit.

The input pen of the present invention may further include a first elastic member that is disposed at a second end of the casing and that makes contact with the vibrating unit.

In the input pen of the present invention, the pen tip may be movable in the vertical direction relative to the casing.

In the input pen of the present invention, the vibration transmission unit may be configured to have a pantograph mechanism in which a plurality of linking members is connected to one another, and the vibration transmission unit may include a second elastic member that contracts in the horizontal direction.

In the input pen of the present invention, the vibration transmission unit may be constituted by leaf springs that protrude in the horizontal direction toward the casing.

In the input pen of the present invention, a grip part may be disposed on the casing, at a position facing the vibration transmission unit in the horizontal direction. Also, the grip part may be configured to displace by being pressed by the vibration transmission unit.

With the present invention, the vertical vibration of the vibrating unit is converted into the horizontal vibration at the vibration transmission unit so as to transmit the vibration to the fingers of a user. As a result, it is possible to reduce the vibration of the pen tip while giving a user a good writing feeling.

### BRIEF DESCRIPTION OF THE DRAWINGS

FIG. 1 is an exterior side view showing an appearance of an input pen according to a first embodiment of the present invention.

FIG. 2 is a schematic cross-sectional view viewed from arrow A-A in FIG. 1, which shows a state in which the input pen does not make contact with an input device.

FIG. 3 is a schematic cross-sectional view showing a state in which the input pen makes contact with the input device.

FIG. 4 is a schematic cross-sectional view showing a state in which the input pen is pressed against the input device.

FIG. 5 is a schematic cross-sectional view showing an overall configuration of the input pen according to a second embodiment of the present invention.

FIG. 6 is a schematic cross-sectional view showing an overall configuration of the input pen according to a third embodiment of the present invention.

### DESCRIPTION OF PREFERRED EMBODIMENTS

### First Embodiment

Hereinafter, an input pen according to the first embodiment of the present invention will be described with reference to the drawings.

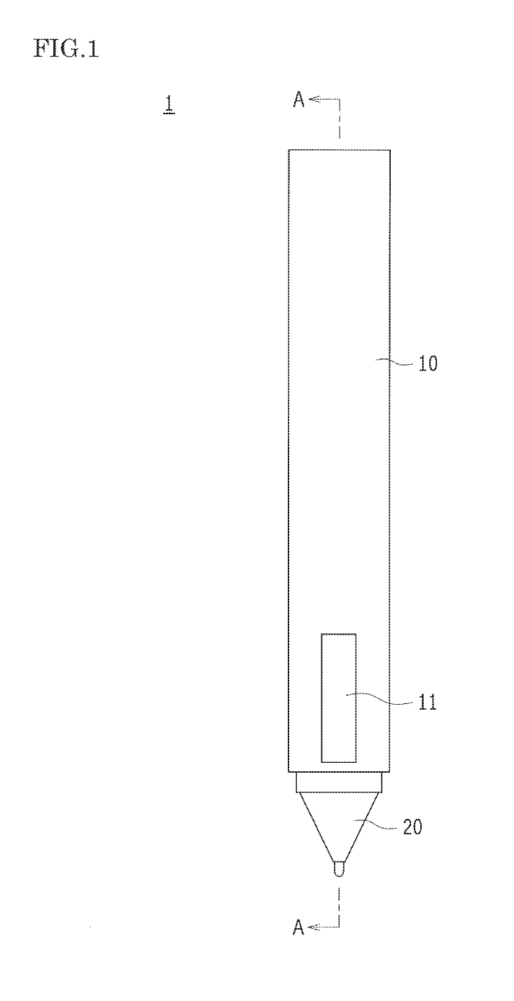

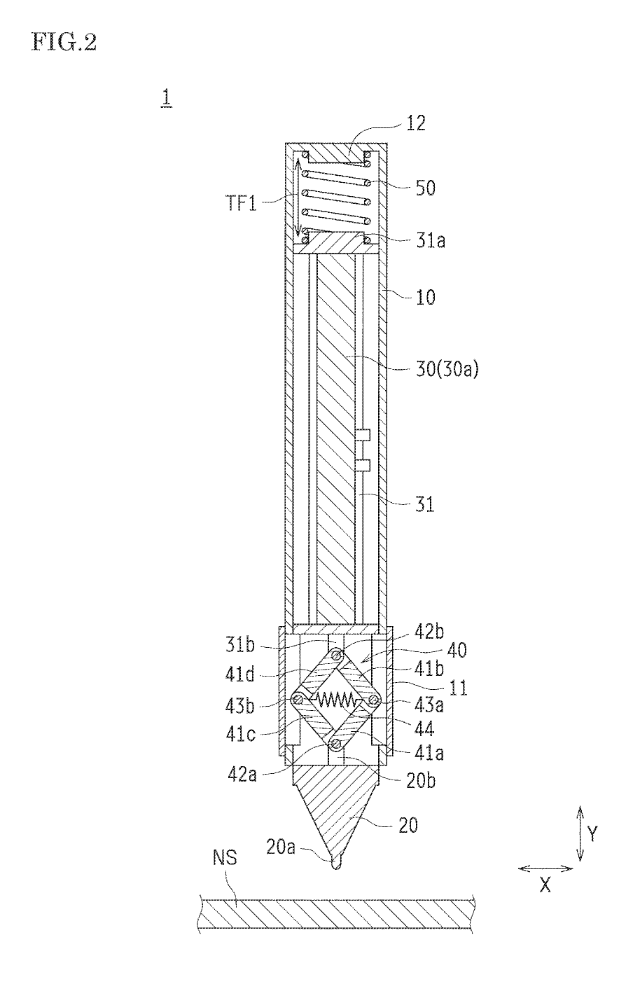

FIG. 1 is an exterior side view showing an appearance of an input pen according to the first embodiment of the present invention. FIG. 2 is a schematic cross-sectional view viewed from arrow A-A in FIG. 1, which shows a state in which the input pen does not make contact with an input device.

An input pen 1 according to the first embodiment of the present invention includes: a casing 10 that is gripped by a user; a pen tip 20 that is disposed at an end of the casing 10 so as to make contact with an input device NS; a vibrating unit 30 that is housed in the casing 10; and a vibration transmission unit 40 that is disposed between the vibrating unit 30 and the pen tip 20.

The casing 10 has a substantially cylindrical shape and is provided with the pen tip 20 at the tip thereof. Hereinafter, for the sake of explanation, a direction along the longitudinal direction of the casing 10 is occasionally referred to as the vertical direction Y, and a direction that is orthogonal to the vertical direction Y is occasionally referred to as the horizontal direction X. Also, in the vertical direction Y, the side on which the pen tip 20 is provided is occasionally referred to as the lower side, and the opposite side thereto is occasionally referred to as the upper side. A grip part 11 is disposed in the vicinity of the lower end of the casing 10. A spring fixing member 12 is disposed on an inner wall of the upper end of the casing 10. The grip part 11 is made of an elastic material such as rubber, and is deformed by being pressed. The spring fixing member 12 fixes an upper end of a vibrating spring 50 (first elastic member). The vibrating spring 50 is not limited to the spring, provided that it is an elastic member.

The external diameter of the pen tip 20 tapers toward the side on which the pen tip 20 makes contact with the input device NS (i.e. toward the lower side in FIG. 2). An input contact part 20a, which protrudes more than the other part, is formed on the tip part of the pen tip 20. The upper end portion of the pen tip 20 has substantially the same external diameter as an internal diameter of the casing 10, and part of the pen tip 20 is housed in the casing 10. That is, the pen tip 20 is movable relative to the casing 10 in the vertical direction Y. The upper end of the pen tip 20 is connected to the vibration transmission unit 40 via a pen-tip-side connecting member 20b that protrudes toward the upper side.

The vibrating unit 30 is constituted by a linear actuator 30a and a holding part 31. The linear actuator 30a has an elongated shape in the vertical direction Y, and also has, inside the linear actuator 30a, a weight that is moved in the longitudinal direction. In the linear actuator 30a, the weight is moved due to a voltage applied to an electromagnet inside the linear actuator 30a, and an inertia force of the weight generates vibration of the linear actuator 30a. The vibration direction and the vibration amount of the linear actuator 30a can be controlled by the direction and magnitude of the voltage applied.

The holding part 31 holds the linear actuator 30a. On the upper end of the holding part 31, a spring contacting member 31a is disposed, which faces the spring fixing member 12 of the casing 10 and makes contact with the lower end of the vibrating spring 50. The lower end of the holding part 31 is connected to the vibration transmission unit 40 via a holding-part-side connecting member 31b that protrudes toward the lower side.

The vibration transmission unit 40 includes: a first linking member 41a; a second linking member 41b; a third linking member 41c; a fourth linking member 41d; a lower-end-side connecting shaft 42a; an upper-end-side connecting shaft 42b; a first horizontal connecting shaft 43a; a second horizontal connecting shaft 43b; and a tension spring 44 (second elastic member). The vibration transmission unit 40 has a pantograph mechanism in which the multiple linking member are connected to one another.

The first linking member 41a, the second linking member 41b, the third linking member 41c and the fourth linking member 41d are elongated arms made of a metal or a rigid plastic. Both ends of each linking member are supported respectively by the corresponding connecting shafts. Hereinafter, for the sake of the explanation, the first linking member 41a, the second linking member 41b, the third linking member 41c and the fourth linking member 41d are collectively referred to, occasionally, as the “linking member”.

The lower-end-side connecting shaft 42a rotatably connects the first linking member 41a and the third linking member 41c to the pen-tip-side connecting member 20b. The upper-end-side connecting shaft 42b rotatably connects the second linking member 41b and the fourth linking member 41d to the holding-part-side connecting member 31b. The first horizontal connecting shaft 43a rotatably connects the first linking member 41a and the second linking member 41b. The second horizontal connecting shaft 43b rotatably connects the third linking member 41c and the fourth linking member 41d.

The linking member is held so that it has an inclined shape in the horizontal direction X from the pen-tip-side connecting member 20b or the holding-part-side connecting member 31b to an internal side surface of the casing 10 (more specifically, to the grip part 11). The position where the first linking member 41a is connected to the second linking member 41b and where the first horizontal connecting shaft 43a is disposed faces, in the horizontal direction X, the grip part 11 (at the right side in FIG. 2). The position where the third linking member 41c is connected to the fourth linking member 41d and where the second horizontal connecting shaft 43b is disposed faces the grip part 11 (at the left side in FIG. 2) provided on the side opposite to the side where the first horizontal connecting shaft 43a is disposed. In the state shown in FIG. 2, the positions where the first horizontal connecting shaft 43a and the second horizontal connecting shaft 43b are respectively disposed are each spaced apart from the corresponding grip part 11.

The tension spring 44 is bridged between the first horizontal connecting shaft 43a and the second horizontal connecting shaft 43b so as to bias the first horizontal connecting shaft 43a and the second horizontal connecting shaft 43b in a direction in which they come close to each other. The spring constant K1 of the vibrating spring 50 is set to meet the relationship represented by an expression “K1>K2”, where K2 is the spring constant of the tension spring 44.

That is, when the relationship “K1<K2” is established, the vibration of the linear actuator 30a is absorbed by the vibrating spring 50. Thus, a sufficient vibration cannot be given to the hand of a user. When the relationship “K1>K2” is set, it seems that the tension spring 44 deforms before the vibrating spring 50 deforms when the pen tip 20 makes contact with the input device NS. However, the deformation of the vibration transmission unit 40 is restricted by the hand of the user gripping the input pen 1, thus the vibrating spring 50 deforms, which easily transmits a sense of touch to the user.

As described above, the vibrating unit 30, the vibration transmission unit 40 and the pen tip 20 are connected in this order from the upper side, and they are movable in the vertical direction Y. As shown in FIG. 2, in the state in which the pen tip 20 does not make contact with the input device NS, when the linear actuator 30a is vibrated, a force (first longitudinal stress TF1 in FIG. 2) is transmitted to the vibrating spring 50. That is, although the vibrating unit 30 is vibrated in the vertical direction Y, the vibration is absorbed by the vibrating spring 50. The vibration transmitted to the vibration transmission unit 40 is not transmitted to the grip part 11, because the vibration transmission unit 40 does not contact with the grip part 11.

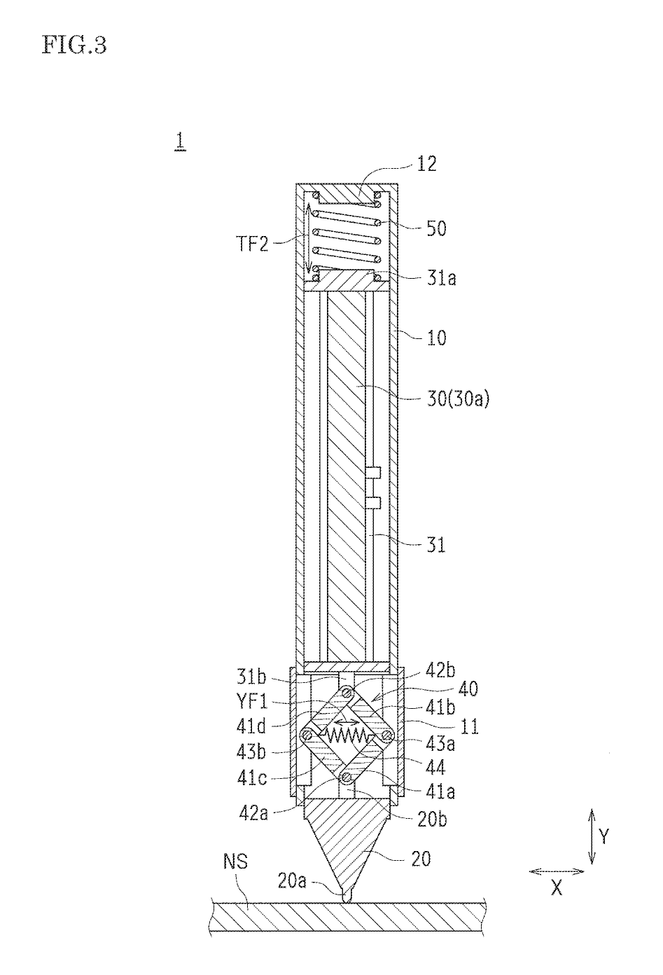

FIG. 3 is a schematic cross-sectional view showing a state in which the input pen makes contact with the input device.

FIG. 3 shows a state in which the input pen 1 comes closer to the input device NS than in the state shown in FIG. 2, where the pen tip 20 is pressed against the input device NS with a small force so that part of the pen tip 20 is housed in the casing 10. Thus, the vibrating spring 50 contracts while the vibration transmission unit 40 extends in the horizontal direction X. In this state, when the linear actuator 30a is vibrated, part of the vibration is absorbed by the vibrating spring 50, however, an acting force (second longitudinal stress TF2 in FIG. 3) is reduced compared to the state shown in FIG. 2, which leads to a force that acts on the vibration transmission unit 40 to vibrate it in the horizontal direction X (first transverse stress YF1 in FIG. 3). In FIG. 3, the positions where the first horizontal connecting shaft 43a and the second horizontal connecting shaft 43b are respectively disposed are shown as if they are spaced apart from the corresponding grip parts 11. However, actually, the vibration transmission unit 40 is vibrated in the horizontal direction X due to the vibration of the linear actuator 30a, and as a result, it repeatedly makes contact with/is spaced apart from the respective grip parts 11. Consequently, a small vibration is transmitted to the fingers of the user who is gripping the grip part 11.

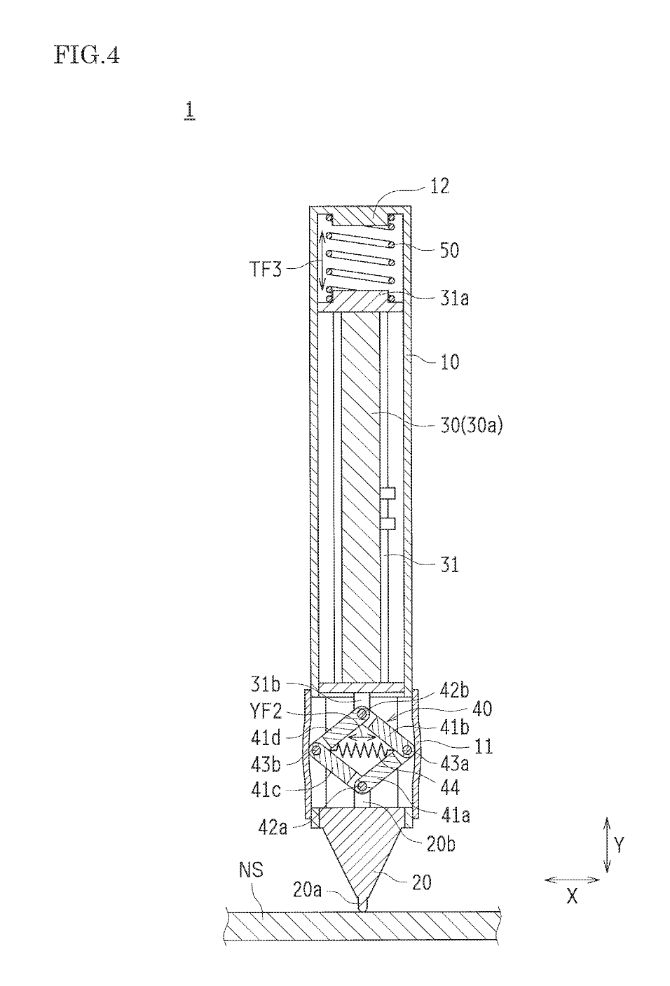

FIG. 4 is a schematic cross-sectional view showing a state in which the input pen is pressed against the input device.

FIG. 4 shows a state in which the pen tip 20 is pressed against the input device NS with a force larger than that applied in the state shown in FIG. 3. Since the pen tip 20 is pressed and further housed in the casing 10, the vibrating spring 50 maximally contracts. Thus, the vibration transmission unit 40 further extends in the horizontal direction X, which more extends the grip part 11. In this state, the vibration of the linear actuator 30a acts on as a force that largely vibrates the vibration transmission unit 40 (second transverse stress YF2 in FIG. 4). Consequently, a large vibration is transmitted to the fingers of the user.

As described above, in this embodiment, the vertical vibration of the vibrating unit 30 is converted into the horizontal vibration at the vibration transmission unit 40 so as to transmit the vibration to the fingers of the user. Thus, this configuration can give a good writing feeling to the user.

Taking into account ease in grip for the user, the size (especially, the width in the horizontal direction X) of the input pen 1 is limited. Thus, it is preferable that the inner diameter of the casing 10 is in the range of about 5 to 10 mm. In order to obtain a sufficient vibration with the linear actuator 30a, the width of at least about 20 mm is required. Thus, it is difficult to obtain a sufficient vibration amplitude by arranging the linear actuator 30a so as to vibrate in the horizontal direction X. In contrast, in the present invention, since the linear actuator 30a is arranged in the vertical direction Y, it is possible to obtain a large vibration amplitude, which results in easy generation of the vertical vibration.

In this embodiment, when the pen tip 20 does not make contact with the input device NS, the vibration of the vibrating unit 30 is absorbed by the vibrating spring 50. When the pen tip 20 makes contact with the input device NS, and as it is pressed against the input device NS with a larger force, the vibration absorbed by the vibrating spring 50 is reduced while the vibration of the vibration transmission unit 40 increases. Thus, depending on the force pressing the pen tip 20 against the input device NS, the intensity of the vibration transmitted to the user changes, which leads to giving the user more real writing feeling.

As described above, since the force transmitted to the vibrating spring 50 and the like changes depending on the pressing force, it is possible to adjust the vibration to transmit to the user.

Since this embodiment includes the vibration transmission unit 40 having a pantograph mechanism, it is possible to obtain the configuration in which the vertical vibration is converted into the horizontal vibration.

Also, by disposing the grip part 11, it is possible to emphasize the part to be gripped by the user, which serves to more reliably transmit the vibration to the user.

### Second Embodiment

Hereinafter, an input pen according to the second embodiment of the present invention will be described with reference to the drawings. Since the overall configuration of the second embodiment is substantially the same as that of the first embodiment, the same reference numerals are used to indicate the same elements and the drawings and description thereof are omitted.

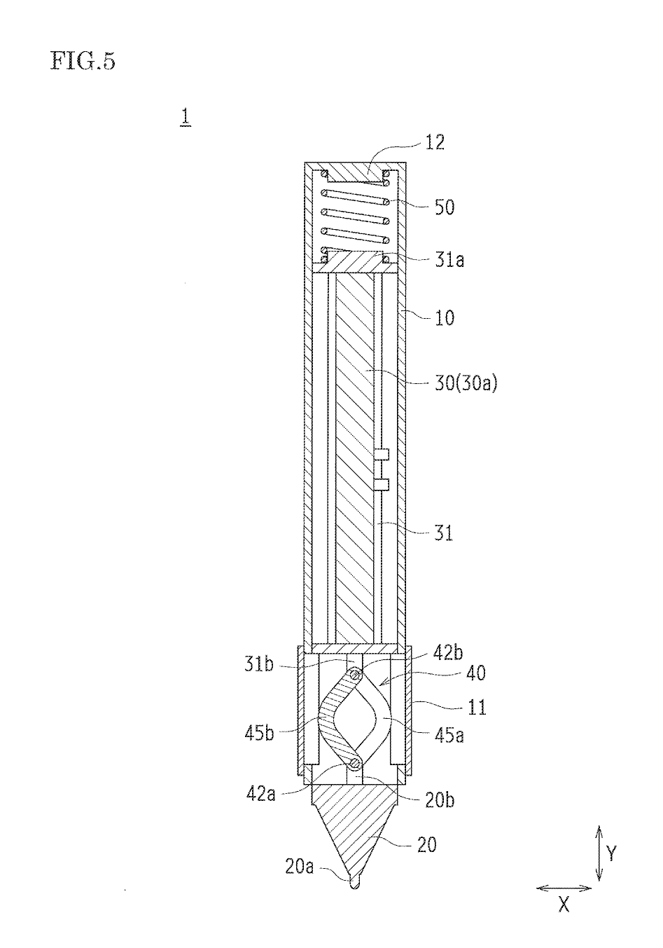

FIG. 5 is a schematic cross-sectional view showing an overall configuration of the input pen according to the second embodiment of the present invention.

In the second embodiment, the configuration of the vibration transmission unit 40 is different from that of the first embodiment. Specifically, in this embodiment, the vibration transmission unit 40 is constituted by a first leaf spring 45a and a second leaf spring 45b. The first leaf spring 45a and the second leaf spring 45b protrude (curve) toward an inner surface of the casing 10 in the horizontal direction X, and their lower ends are connected to the pen-tip-side connecting member 20b via the lower-end-side connecting shaft 42a while their upper ends are connected to the holding-part-side connecting member 31b via the upper-end-side connecting shaft 42b. The first leaf spring 45a and the second leaf spring 45b are arranged so as to protrude in the directions opposed to each other.

In the second embodiment, similarly to the first embodiment, the vertical vibration of the linear actuator 30a is converted into the horizontal vibration of the vibration transmission unit 40. That is, when the pen tip 20 is pressed against the input device NS, the first leaf spring 45a and the second leaf spring 45b curve so as to extend in the horizontal direction X, and then make contact with the respective facing grip parts 11. When the vibrating spring 50 contracts, the force transmitted to the vibration transmission unit 40 increases. Thus, the horizontal vibration of the first leaf spring 45a and the second leaf spring 45b increases so as to transmit a large vibration to the user. As described above, it is possible to obtain the configuration in which the vertical vibration is converted into the horizontal vibration by use of the leaf springs as the vibration transmission unit 40.

### Third Embodiment

Hereinafter, an input pen according to the third embodiment of the present invention will be described with reference to the drawings. Since the overall configuration of the third embodiment is substantially the same as those of the first embodiment and the second embodiment, the same reference numerals are used to indicate the same elements and the drawings and description thereof are omitted.

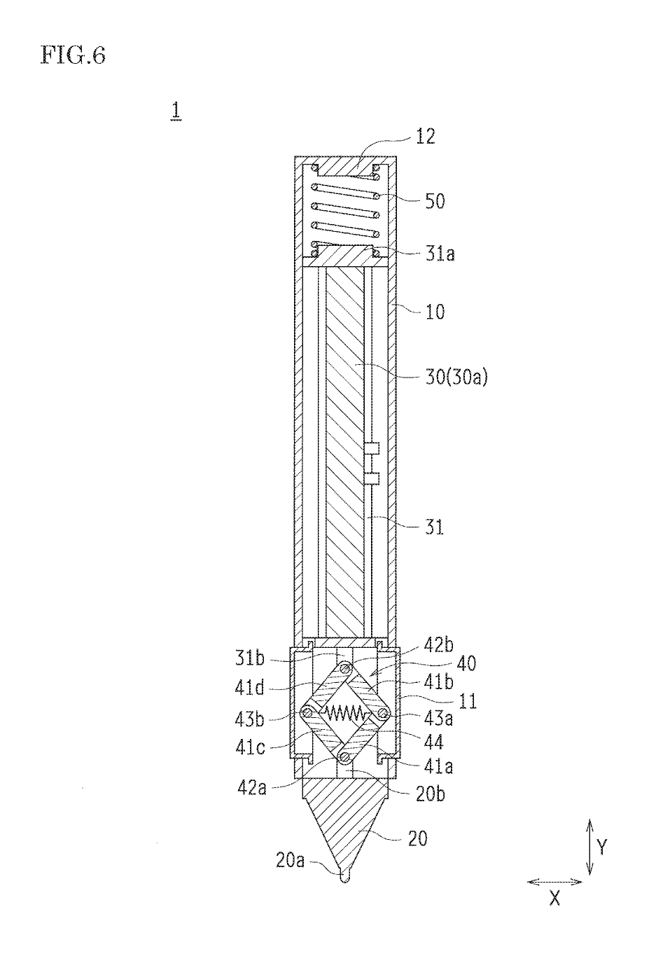

FIG. 6 is a schematic cross-sectional view showing an overall configuration of the input pen according to a third embodiment of the present invention.

In the third embodiment, the configuration of the grip part 11 is different from that of the first embodiment. Specifically, in the first embodiment, the grip part 11 made of rubber is disposed so as to cover an opening provided in the casing 10. In the third embodiment, the grip part 11 made of a metal or a rigid plastic is fitted in the opening provided in the casing 10. The grip part 11 is only required to be disposed so as to not disengage from the casing 10, by including a convex part or the like to engage with the casing 10. When the grip part 11 is pressed by the vibration transmission unit 40, the grip part 11 moves in the horizontal direction X so as to transmit the vibration to the user. As described above, the grip part 11 is only required to have a configuration in which it is displaced by being pressed by the vibration transmission unit 40, thus it is possible to appropriately choose the material.

The foregoing embodiments are therefore to be considered in all respects as illustrative and not limiting. The scope of the invention is indicated by the appended claims rather than by the foregoing description, and all modifications and changes that come within the meaning and range of equivalency of the claims are intended to be embraced therein.

What is claimed is:

1. An input pen for an input device, comprising:
a casing;
a pen tip disposed at a first end of the casing;
a vibrating unit housed in the casing; and
a vibration transmission unit disposed between the vibrating unit and the pen tip,
wherein, when a longitudinal direction of the input pen is set to a vertical direction and a direction that is orthogonal to the vertical direction is set to a horizontal direction, the vibrating unit is configured to vibrate in the vertical direction, and the vibration transmission unit is configured to convert the vibration of the vibrating unit into a vibration in the horizontal direction.

2. The input pen according to claim 1,
wherein a linear actuator is used as the vibrating unit.

3. The input pen according to claim 1, further comprising a first elastic member that is disposed at a second end of the casing and that makes contact with the vibrating unit.

4. The input pen according to claim 1,
wherein the pen tip is movable in the vertical direction relative to the casing.

5. The input pen according to claim 1,
wherein the vibration transmission unit is configured to have a pantograph mechanism in which a plurality of linking members is connected to one another, and
wherein the vibration transmission unit includes a second elastic member that contracts in the horizontal direction.

6. The input pen according to claim 1,
wherein the vibration transmission unit is constituted by leaf springs that protrude in the horizontal direction toward the casing.

7. The input pen according to claim 1,
wherein a grip part is disposed on the casing, at a position facing the vibration transmission unit in the horizontal direction, and
wherein the grip part is configured to displace by being pressed by the vibration transmission unit.
